(19) United States
(12) Patent Application Publication
(10) Pub. No.: US 2010/0100477 A1
(43) Pub. Date: Apr. 22, 2010

(54) COMPUTER NETWORK BASED SYSTEM AND METHOD FOR EDUCATION ACCOUNT REGISTRATION, INVITATION AND TRACKING

(76) Inventor: Peter P. Giammanco, Jenkintown, PA (US)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/564,353

(22) Filed: Sep. 22, 2009

Related U.S. Application Data
(60) Provisional application No. 61/098,842, filed on Sep. 22, 2008.

(51) Int. Cl. G06Q 40/00; G06Q 50/00; G06Q 20/00; G06F 15/16

(52) U.S. Cl. 705/39; 705/327; 705/35; 709/217; 709/206

(57) ABSTRACT

A web based system and method allows an adult relative or custodial adult subscriber to notify others of the pending special occasion for the designated person (beneficiary). The subscriber is provided the option to post family pictures and to set up a transfer account. The list of transfer accounts is then emailed or mailed notification of said date and is directed to the web site. The web site directs the invited persons to transfer money to the account. The transfer account's purpose is to allow financial gift giving for the custodian's designated account and purpose. The account is directed for educational and or special needs. The custodial recipient receives a notification of each gift.

This application claims the benefit of U.S. Provisional Patent Application No. 61/098,842, filed Sep. 22, 2008, which is incorporated by reference herein in its entirety.

### FIELD OF THE INVENTION

The present invention relates to electronic commerce systems and methods.

### BRIEF DESCRIPTION OF THE DRAWINGS

FIG. 1A is a block diagram of an exemplary system.

FIG. 1B is a flow chart of method performed by the system of FIG. 1A.

FIG. 2 is a diagram of the education account registration and invitation system of FIG. 1A.

FIG. 3 is a screen shot of a main entry panel and home page of the system of FIG. 2, with “Learn More” links for more information on “How it works”, “Setup an Account,” and “Send a Gift.”

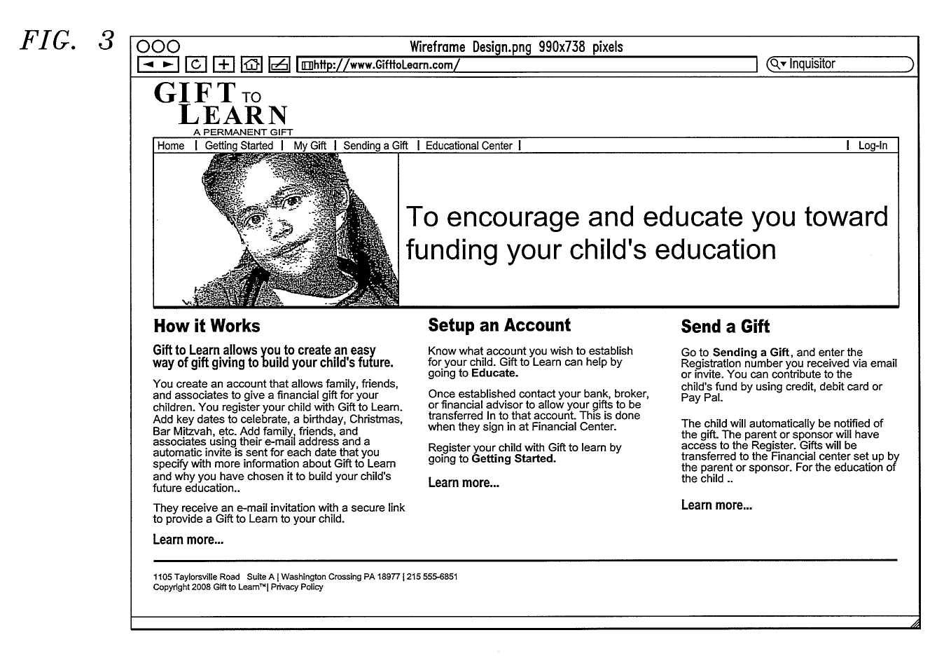

FIG. 4 is a screen shot of the “How it Works” page accessed from the link in FIG. 3.

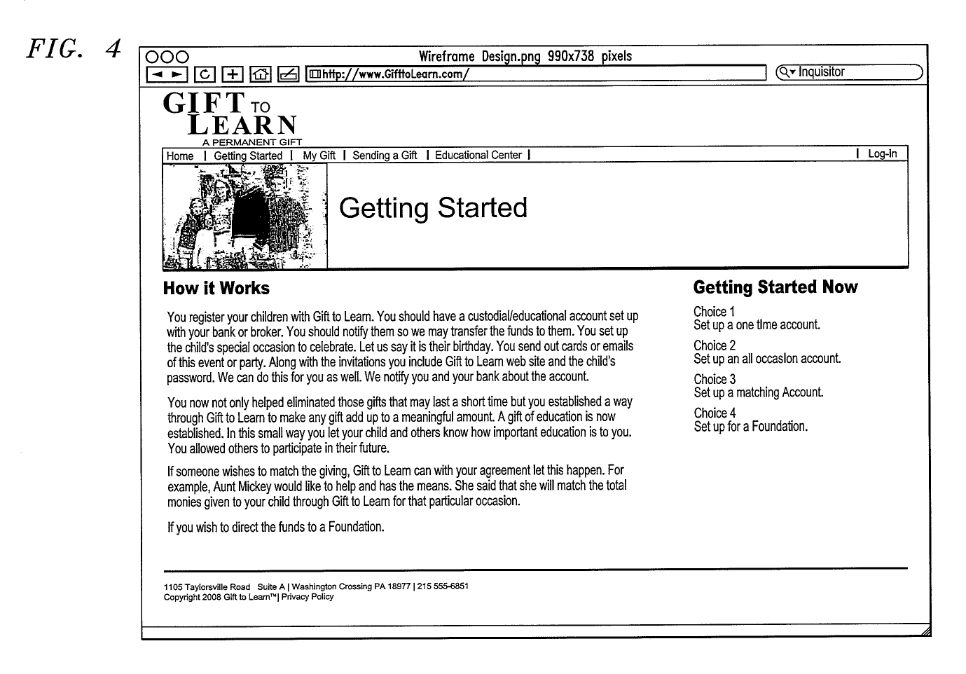

FIG. 5 is a screen shot of a subscriber registration page accessed from the link in the “Getting Started” page of FIG. 3.

FIG. 6 is a screen shot of the “Setup an Account” page accessed from the “Start a New Account” link in FIG. 5.

FIG. 7 is a screen shot of the “Educational Center” page accessed from the link shown in FIG. 3.

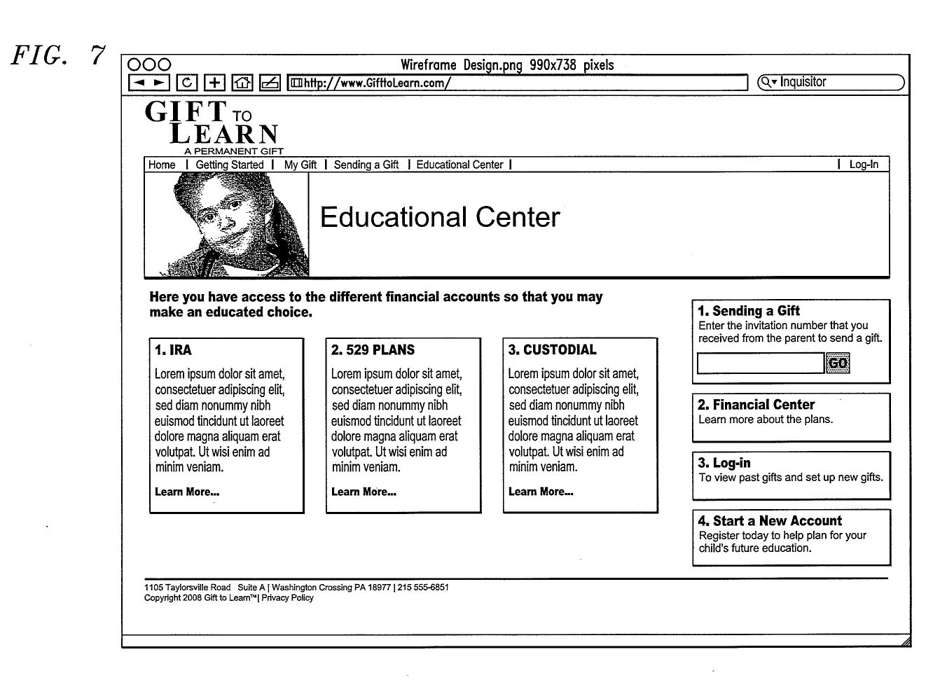

FIG. 8 is a screen shot of the “Send a Gift” page accessed from the link in FIG. 3.

FIG. 9 is a screen shot of the “Giving a Gift” page accessed from the “Send a Gift” line in FIG. 8.

FIG. 10 is a screen shot of a log-in page for a returning subscriber or new account setup.

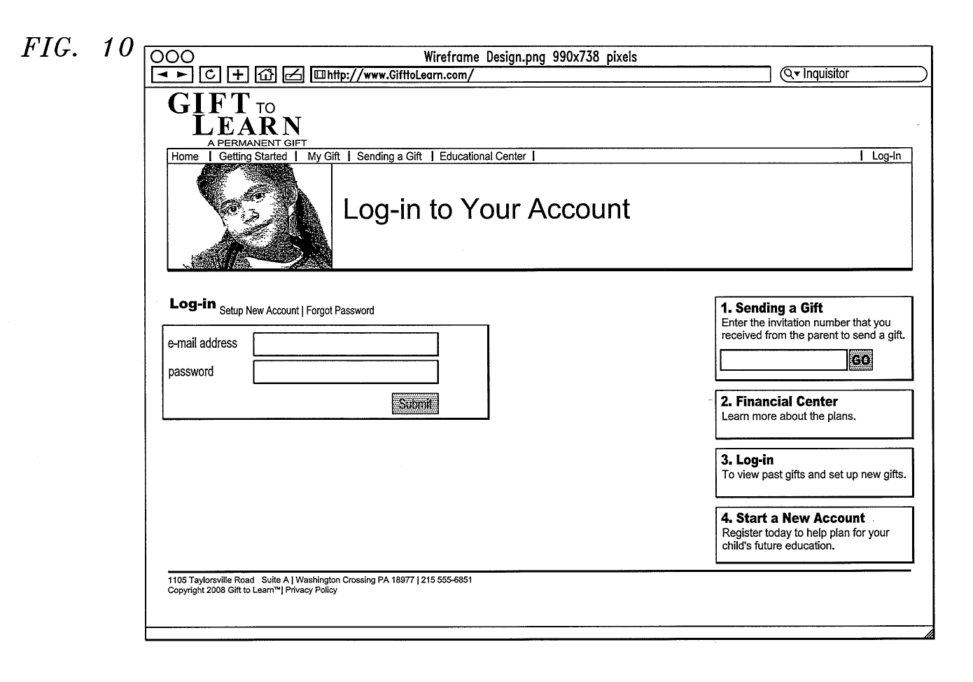

FIG. 11 is a screen shot of an account summary page displayed to a returning subscriber, showing all the subscriber's accounts, occasions, and an address book for sending email invitations to make a donation.

FIG. 12 is a screen shot of a detailed transaction history for the John Smith account shown in FIG. 11.

FIG. 13 is a screen shot of a page to allow the financial institution to arrange for new or existing accounts to accept or access transfers.

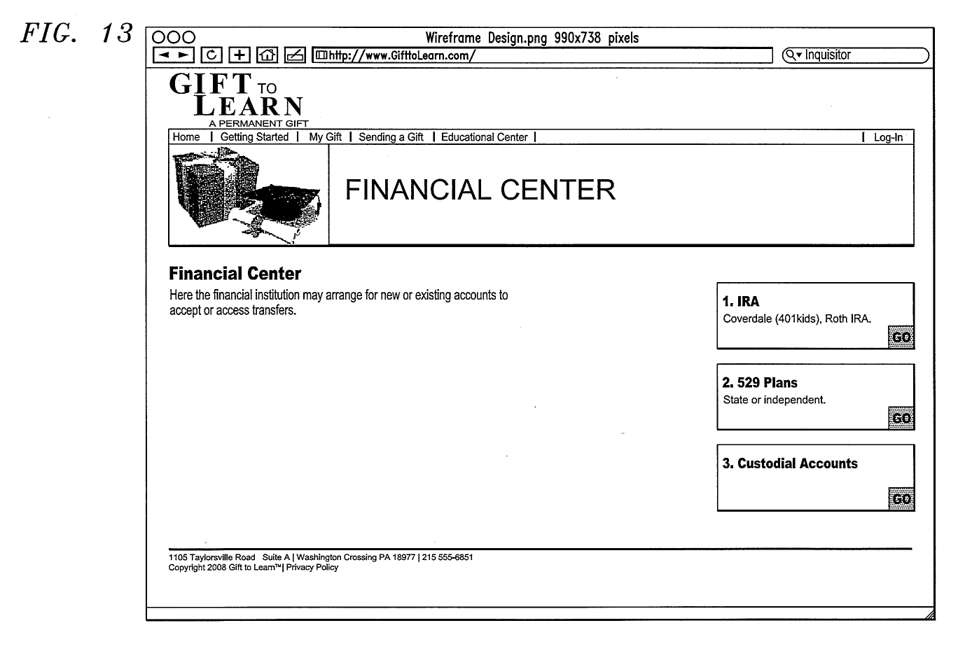

### DETAILED DESCRIPTION

This description of the exemplary embodiments is intended to be read in connection with the accompanying drawings, which are to be considered part of the entire written description.

Overview

Embodiments are described herein for an electronic computer network implemented education account registration, invitation and tracking service and method that provides a new and innovative Web experience to facilitate giving to an individual beneficiary's educational fund. Some embodiments provide services and tools to engage a family in the process of saving for their child's future educational expenses and to provide a vehicle for other individuals that care about that child to make contributions to his/her future in a secure, fun, and meaningful way.

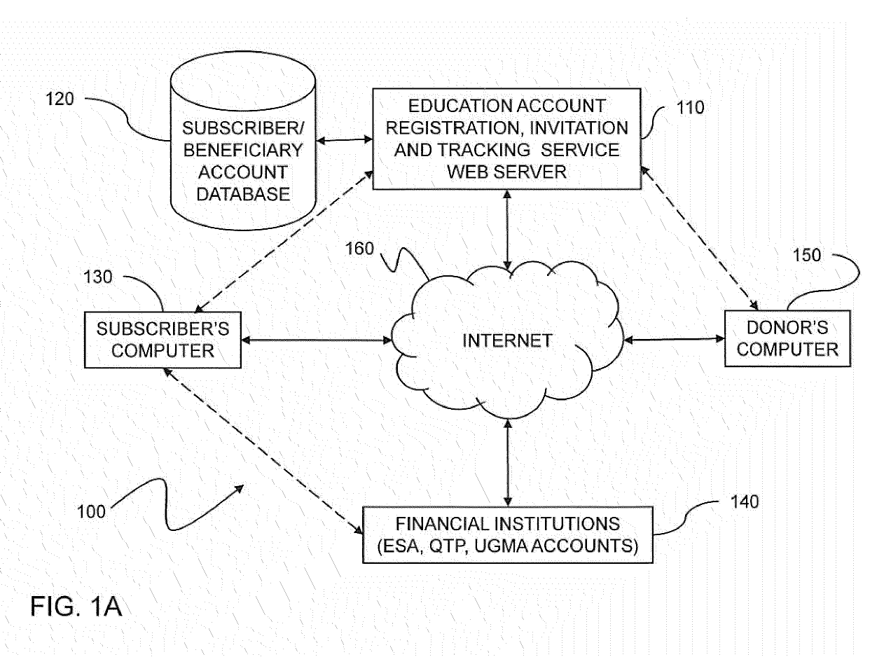

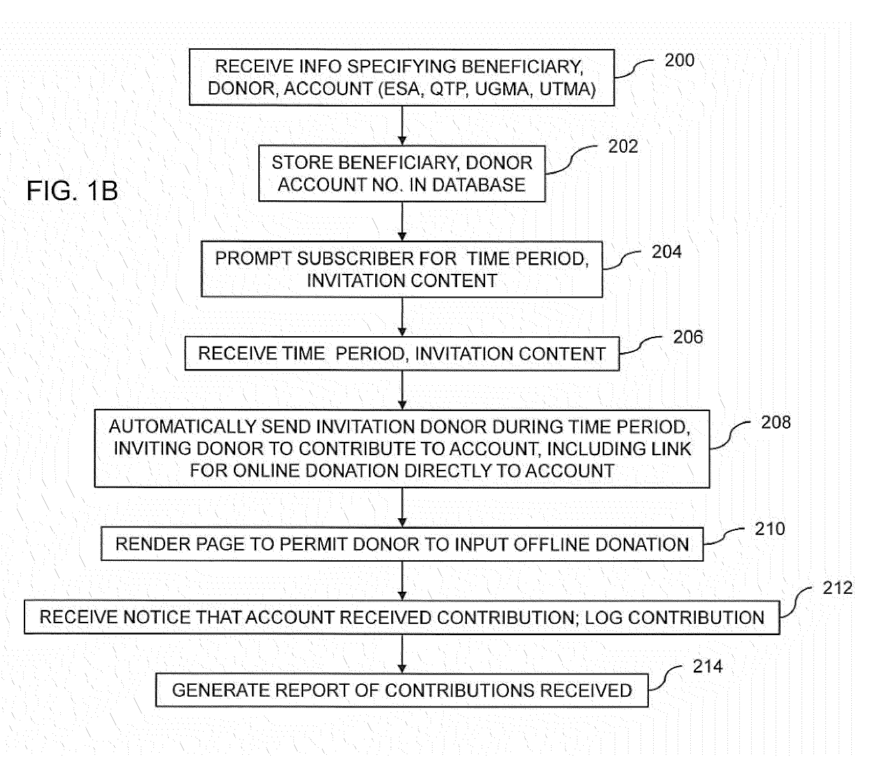

FIG. 1A is a block diagram of a computer network implemented system 100. The solid lines represent (direct or indirect) network connections, which may include wired and/or wireless connections. The dashed lines represent relationships and/or virtual connections. The system 100 includes an education account registration, invitation and tracking service web server 110. The web server 110 maintains the subscriber and beneficiary account database 120 with each subscribers account information, and information related to the beneficiary account(s) established by each subscriber. The web server also renders the user interface web pages for subscribers and donors. The web pages allow the subscribers to establish and track accounts, and allows donors to donate gifts to the beneficiaries' accounts, as described below. The web server may include one or more computer processors programmed to manage the database 120, render web pages, receive inputs from subscribers and donors and issue invitations and notifications. If the web server includes multiple processors, the various tasks described herein may be distributed among the processors an any configuration.

The database 120 may be managed by a database management system running on server 110, such as Oracle database, by Oracle Corporation of Redwood Shores, Calif. A subscriber transacts electronic transactions with the server 110 using the subscriber's computer 130, which is connected directly or indirectly to the Internet 160. The subscriber also establishes one or more education accounts (e.g., ESA, QTP or UGMA) for a beneficiary with at least one financial institution 140. The accounts may be established via eCommerce tools, or by face-to-face transaction. Subsequently, a donor can electronically transfer gifts to the beneficiary's account at the financial institution 140 using the web page rendered by the server 110 on the computer of the donor 150.

FIG. 1B is a flow chart for a method of using the system 100 of FIG. 1A, comprising a computer readable storage medium 120 storing a database of subscriber records, each subscriber record associated with a respective subscriber, and a computer processor 110 connected to the computer readable storage medium 120 and to a communications network 160.

At step 200, the server 110 for the education account registration, invitation and tracking web service renders a web page for display on the subscriber's computer 130 requesting information, and receives from the subscriber's computer 130 via the network 160, information specifying at least one beneficiary, at least one donor, and at least one account from the group consisting of a Coverdell Education Savings Account (ESA), a Qualified Tuition Plan (QTP) under Internal Revenue Code section 529, a Uniform Gift to Minors Act (UGMA) account and a Uniform Transfers to Minors Act (UTMA) account. In a preferred embodiment, the server 110 is configured to receive inputs from a plurality of subscribers' computers 110, each subscriber's information optionally including plural beneficiaries, and for each beneficiary, optionally plural associated accounts and plural associated donors. Additional information collected for each beneficiary may include birthday, college start date, and the date of any lifecycle events (baptism, bar/bat mitzvah, confirmation, graduation, or the like) for which invitations should be sent.

Donor information may include donor name, nickname, title, email address and relationship.

At step 202, server 110 stores the information related to each beneficiary, each donor, and each account in the subscriber beneficiary account database 120.

In some embodiments, the information is stored in a relational database. The distribution of the invitations may be automatically selected by the server 110. In some embodiments, the donors can be associated with the subscriber (for example, in the subscriber's address book, stored in database 120), so that every time the subscriber sends an invitation, the invitation can optionally be sent to every donor associated with that subscriber (regardless of which beneficiary is named in the invitation). In some embodiments, donors are associated with specific beneficiaries, and any donor identified in one of the donor records may be associated with any one or more beneficiaries, so that invitations to make contributions that are sent to a donor can optionally be limited to each time an invitation is sent for any of the beneficiaries with which that donor is associated. For example, in a family having children from a previous marriage of the father, children from a previous marriage of the mother, and children the father and mother had together, invitations related to each individual child beneficiary may optionally be limited to only those donors who have a blood relationship with that child. In some embodiments, the distribution for every invitation is selected individually by the subscriber, from the subscriber's address book and/or manually input contacts.

At step 204, the server 110 renders a web page prompting the subscriber to enter at least one time period during which one or more invitations are to be sent. The server 110 stores the time period in one or more records in the database 120, the one or more records being associated with the subscriber. In some embodiments, the time period is a single day, such as a date a few weeks before the beneficiary's birthday. In some embodiments, the time period includes multiple days, such as a few weeks before the beneficiary's birthday and a few weeks before Christmas. In some embodiments, the time period includes a designation of a particular time or time window during the selected day (e.g., at 2 AM, or between 2 and 3 AM). In some embodiments, the user inputs one or more event dates (e.g., the beneficiary's birthday and graduation date), and separately inputs the interval (e.g., 2, 3 or 4 weeks) by which the invitation should precede the event. In some embodiments, the subscriber individually inputs a set of one or more invitation dates for each respective beneficiary. In other embodiments, the subscriber inputs a single set of one or more invitation dates (e.g., Christmas) that is used to send respective invitations for each respective beneficiary.

In some embodiments, the server processor 110 is further configured to render a web page to prompt the subscriber to input content for the invitation. For example, the web page may provide one or more subscriber-customizable templates from which the subscriber can select. The web pay may permit the subscriber to create a new template or upload a previously developed invitation in the form of a graphic file (e.g., JPEG, TIFF or BMP). In some embodiments, the subscriber can provide individual content for each beneficiary. In some embodiments, the subscriber provides a template that is merged with specific information (e.g., name and birthday) for each individual beneficiary stored in database 120, to automatically create the text for the invitation. In some embodiments, the graphic elements to be included in the invitation for each beneficiary are individually associated with respective beneficiaries, so that each invitation can have a background pattern or photograph that is unique to a beneficiary.

In alternative embodiments, invitations are automatically generated in association with the beneficiary's birthday, Christmas, and any other lifecycle events entered in the system, without requiring scheduling of individual invitations by the subscriber. The server 110 renders a web page instructing the subscriber at the time of entering beneficiary data and donor data, that by entering the beneficiary and donor data into the database 120, the subscriber is requesting that invitations automatically be sent to the donors at a prescribed time (e.g., two, three or four weeks) before each event associated with the beneficiary. The automated system may include respective templates for birthdays, holidays and life-cycle events, and may be merged with the beneficiary and donor identification information to form the invitation content, so that the automatically generated invitations are customized for the particular time at which they are sent.

At step 208, the server 110 automatically sends via the network 160, during the time period(s) selected by the subscriber, an invitation to the donor to contribute to the account. The invitation includes information (such as a link or Uniform Resource Locator) to direct the donor to a web page for making an online contribution to the account. In some embodiments, each invitation is for a specific beneficiary, and the link rendered by the server 110 directs the donor to a page for making a contribution to that individual's account. In some embodiments, the invitations may be sent on behalf of plural beneficiaries (e.g., a few weeks before Christmas), and the at least one web page prompts the user to select one beneficiary from among the plurality of beneficiaries. In some embodiments where the invitations may be sent on behalf of plural beneficiaries, the link directs the user to a single account (such as a payment processing service account of the subscriber), from which the subscriber can then distribute the contributions to the individual beneficiaries.

In some embodiments, the information in the invitation includes a link to a web page operated by a payment processing service (e.g., Amazon payments), such that the web page is configured to allow the donor to make an online contribution to the account via the web page of the payment processing service. Contributions are then made by donors to the subscriber's account with the payment processing service, along with transaction information (e.g., identification of the invitation to which the donor responded, identification of the donor, identification of the beneficiary, and amount). The subscriber can then use this information to perform an online transfer of the contribution from the subscriber's account at the payment processing service to the beneficiary's account at a financial institution. In some embodiments, the donor first inputs the information on the amount and donor, which is received by the server 110 as well as the processing service or financial institution that receives the contribution.

In other embodiments, the information in the invitation to direct the donor includes a link to a web page operated by a financial institution (e.g., a bank) at which the beneficiary's account is maintained, such that the web page is configured to allow the donor to make an online contribution to the account via the web page of the financial institution.

At step 210, the computer processor 110 is configured to render a web page that permits the donor to input an amount of an offline contribution. An offline contribution may be any gift made by cash or check to be deposited in the beneficiary's account. Any offline contribution that is input into the server in response to the web page can subsequently be included in any report or contribution list generated by the server 110.

At step 212, the server 110 receives a notice indicating that the account has received a contribution. Depending on the method of transfer used, the notice may come from the payment processing service or financial institution, or from a process in server 110 that is internal to the contribution process.

At step 214, the server 110 generates a report containing a list of contributions that have been made to the account. In some embodiments, the information includes one or more of the beneficiary, the donor, the amount, the date of the contribution, and whether the contribution was made online or offline.

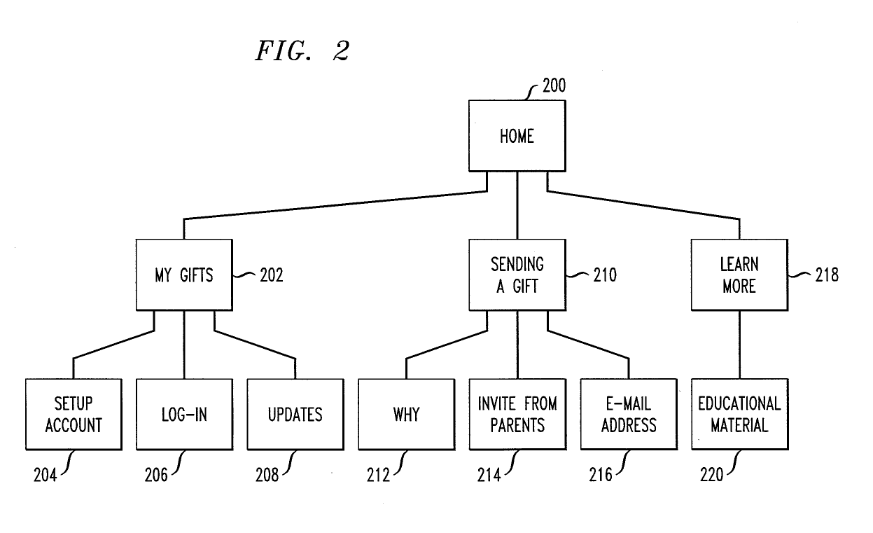

FIG. 2 is a tree diagram showing the various pages for one example of the subscriber's view of the Web application hosted by the server 110 in FIG. 1A. Users can enter the home page 200. A “My Gifts” page 202 provides a subscriber access page 204 to set up an account, a log-in page 206 for accessing the account once it is set up, and an updates page 208 updating an existing subscriber's account (for example, to add a beneficiary). The sending a gift page 210 provides links to a why page 212 with detailed information on the method and system, an “invite from parents” page 214 for sending email invitations to donors, and an email address page 216 for managing the subscriber's address book, containing the email addresses of invitees. A “learn more” page 218 provides access to educational materials 220 about the various education account options.

In preferred embodiments, prior to setting up the beneficiary's account, at least one educational fund has already been established with a financial institution 140 on behalf of the beneficiary as a Coverdell Education Savings Account (ESA) also known as an educational IRA, a Qualified Tuition Plan (QTP) under Internal Revenue Code section 529 and/or Uniform Gift to Minors Act (UGMA) account or Uniform Transfers to Minors Act (UTMA) account. Collectively, the ESA, QTP, UGMA and UTMA are referred to below as education savings funds. It will be understood that the term education savings fund below refers to any combination of at least one of these types of accounts.

Solution Summary

The service provider's services can be summarized in the follow steps/features:

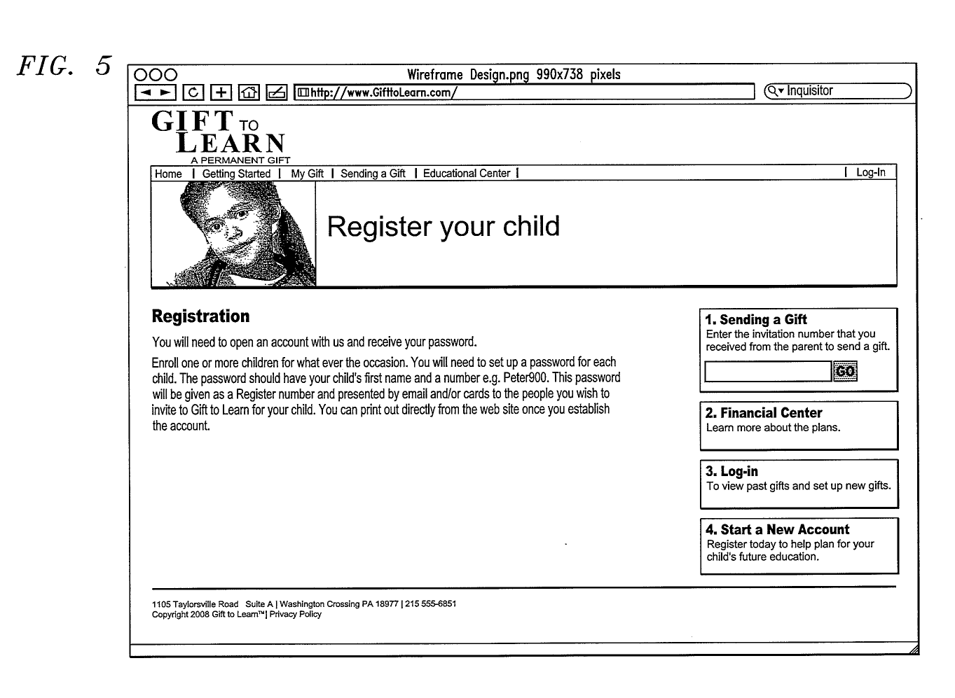

1. Registration (FIG. 5)—Individual users register for a subscription with the service. The subscriber's account is established and is associated with a security password and/or optional additional authentication information. All of the subscriber's information, including the data for all accounts set up by the user are maintained in the subscriber/beneficiary account database 120, which is stored in a machine readable storage medium, such as a hard disk drive, optical disk, solid state memory, or the like.

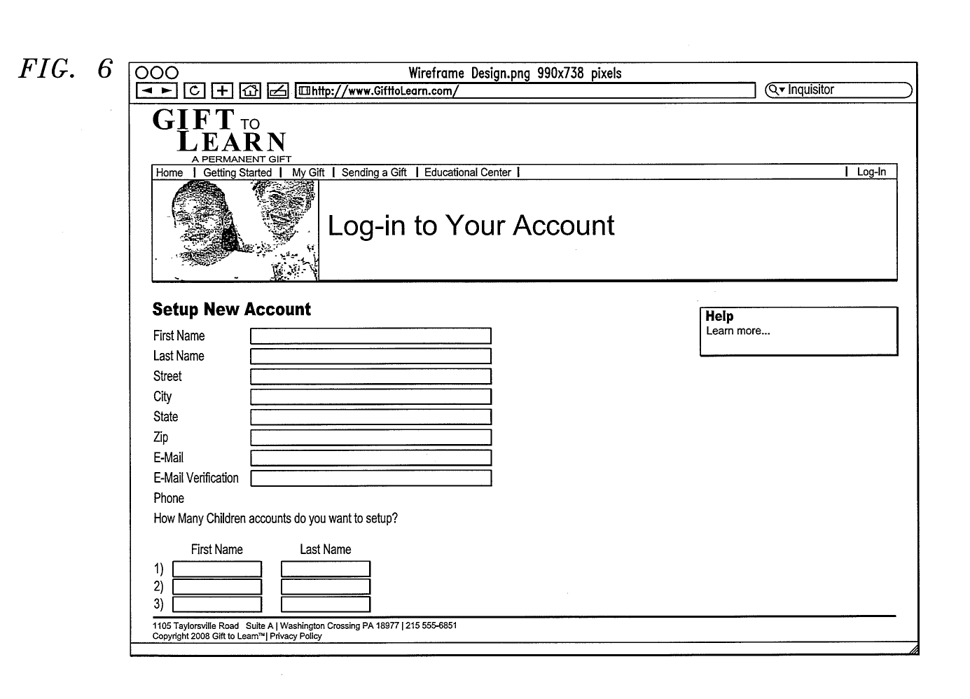

2. Account Setup (FIG. 6)—Subscribers will configure their accounts which provide a container/link to a specific education savings fund that has already been established on behalf of the beneficiary. In addition to inputting the relevant account information to the web page for the registration, invitation and tracking service, the subscriber takes any action required by the financial institution at which the educational account is established (which may be set up entirely online, face-to-face, or via mail). The information for each account is stored in the database 120, and associated with the subscriber.

The system provides enhanced security by providing a method and system that allows a plurality of donors to transfer money to the education account at financial institution 140 without having direct access to the account. Once the information (account number and the like) relating to the beneficiary's account is input to the system 110, donors can make donations to the beneficiary's account indirectly via the system 110. The system 110 is given the security authorization to transfer money to the account at financial institution 140 on behalf of the donors, but the donors themselves do not need to have the ability to access the beneficiary's account at all. Thus, a plurality of donors are accommodated by giving system 110 access to transfer money into the beneficiaries' accounts at the financial institutions 140, limiting the distribution of the beneficiaries' account information.

3. Promotion—Subscribers can solicit and accept donations to their accounts via creating a customizable landing page on the Worldwide Web (Web) or any similar global communications network. Preferably, the setup for configuring the landing page is password protected, so that only the subscriber can change the landing page format and content. The subscriber then promotes this page by sharing the link and password through email or other delivery methods. In some embodiments, the subscriber is presented with a template page that allows the subscriber to customize the text, upload one or more photographs, and/or select the arrangement and appearance of these elements on the page. In some embodiments, the user is provided with a template to set up customized email invitations and follow-up emails inviting donors to make gifts to the beneficiary, and providing a link to the subscriber's page for donating a gift to that beneficiary.

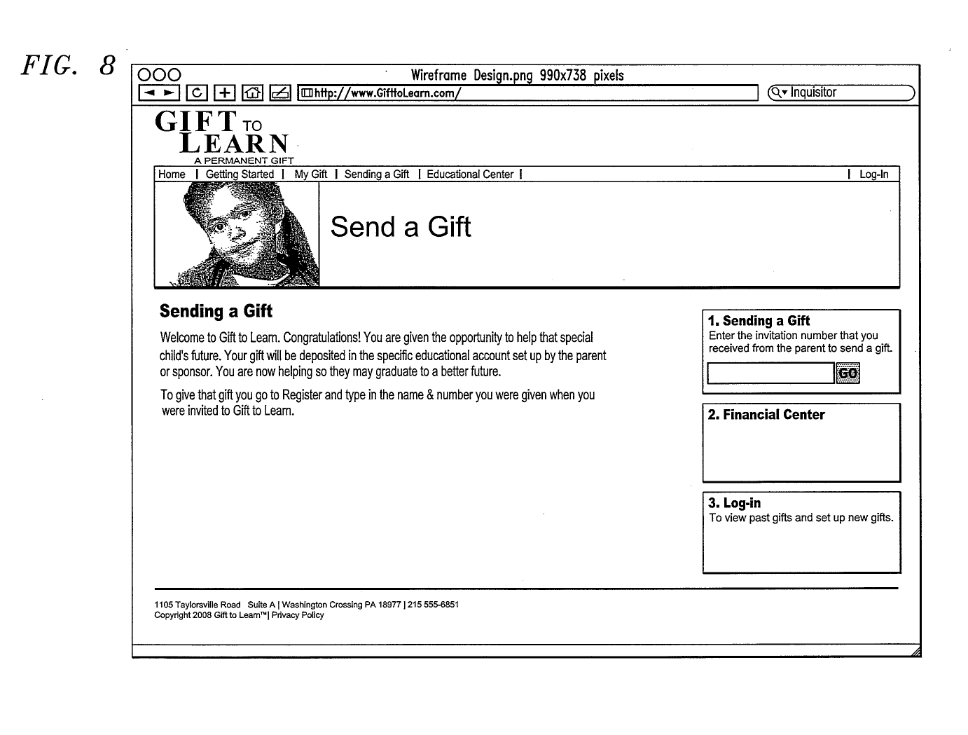

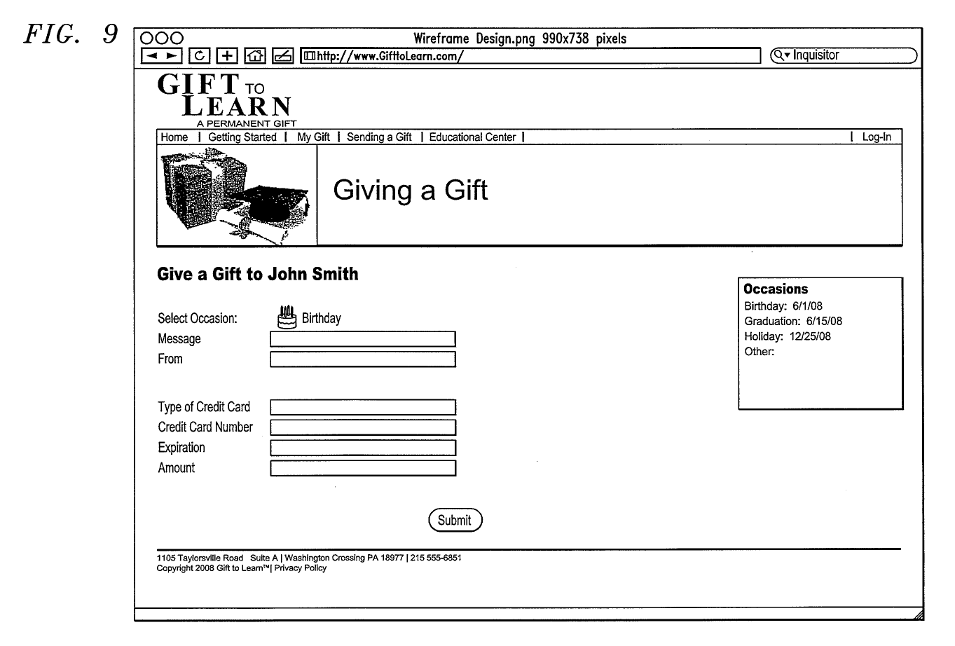

4. Accepting Donations (FIGS. 8 and 9)—When an invitee (donor) directs his or her web browser to the uniform resource locator identified in the invitation email, the server 110 renders the landing page as configured by the subscriber for display on the donor's computer. Via the account landing page donors can make donations using credit card, debit card, prepaid card, electronic funds transfer, or payment processing services (such as PayPal). Other appropriate payment methods may also be used. The payments are electronically transferred by the server 110 to the beneficiary's account, without providing the beneficiary's sensitive account information to the donor. An on screen and email confirmation is sent to the donor for his/her records. In some embodiments, the landing page provides an indication of the total gifts received by this beneficiary to date.

5. Donation Tracking—Subscribers will receive email notifications when donations are made. In some embodiments, the subscriber is provided with a tool and templates for sending thank-you emails to the donors. In some embodiments, a thank-you email is automatically generated and sent.

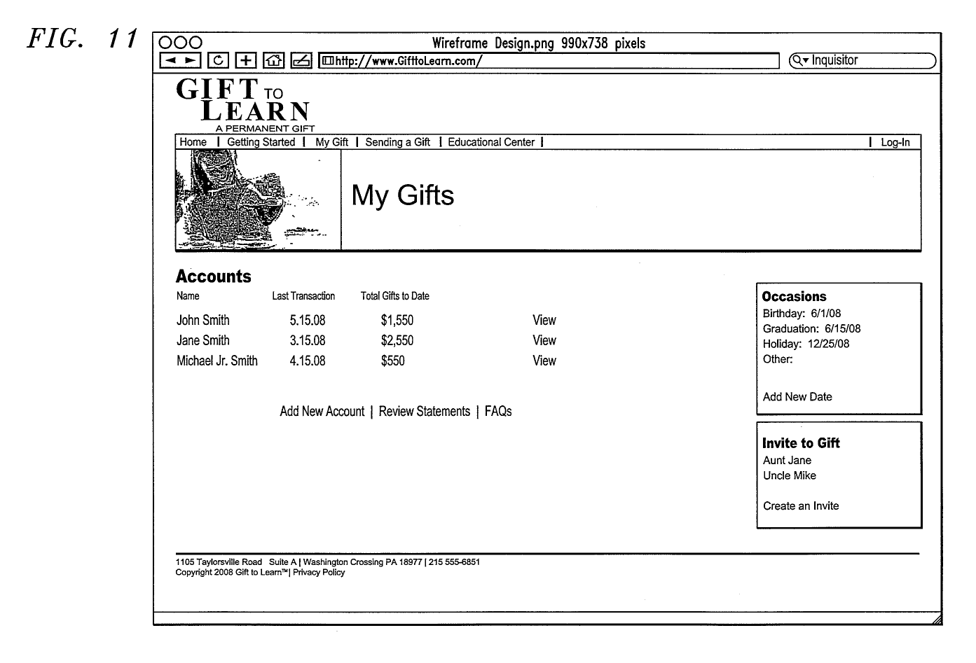

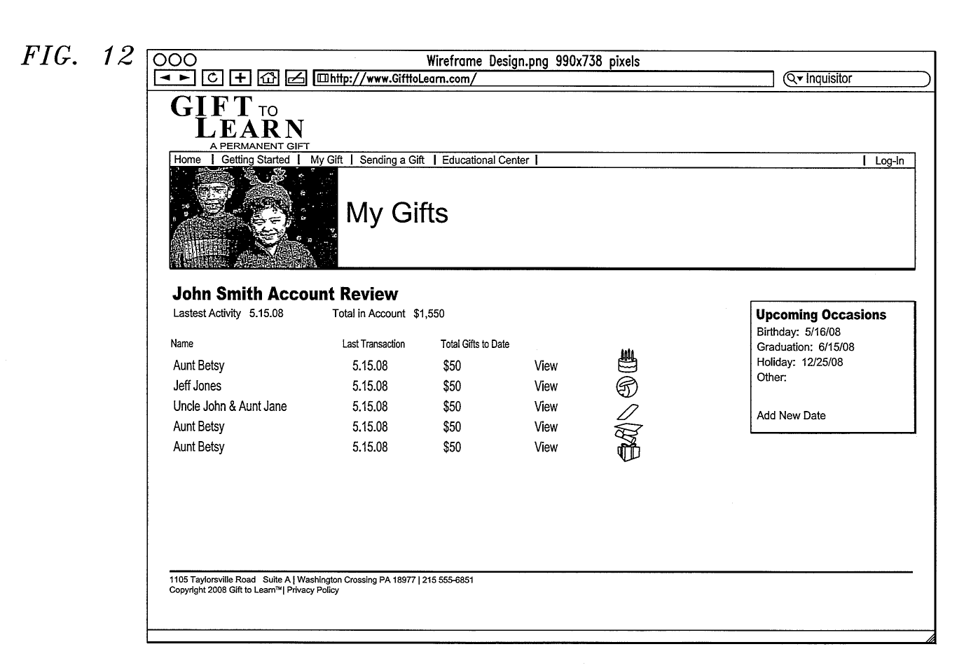

Subscribers will also have access to an account dashboard (FIGS. 11 and 12) to track donations over time as well as viewing a transaction log of donations and movement of those funds directly into their education savings account/fund. In some embodiments, the service provides the subscriber with a tool to track follow-up and or thank-you notes to the donors.

### Example

Account Link/Transfers—In a preferred embodiment, the service provides a conduit/pathway for accepting donations and facilitating a transfer from the donor to the educational fund. In preferred embodiments, the registration, invitation and tracking service does not hold the funds. Rather, the donors gifts are transferred immediately into the beneficiary's account at the financial institution 140. The service provider may employ third parties to help execute these transactions whether they are made by a credit card, debit card, prepaid card, electronic funds transfer, PayPal, Amazon, or the like.

Engagement—The service provides a conduit for contributing to an educational fund by providing tools and features for vertical engagement. The service provides subscriber tools and methods to create customized and themed donation landing pages, send and receive e-Card solicitations and thank-you notes, and monitor progress through a dashboard which tracks donations over time. The tools may include invitation templates, reminder templates, and thank you templates, and an address book for storing contact information of potential donors. The tools allow the educational account/fund holders and donators to be fully engaged in achieving educational savings goals for the beneficiary (youth) they care about.

Additional Solution Features

1. Web-based solution built on supportable and maintainable technologies, which may include a server based application with thin clients operating a browser based graphical user interface, developed using Java or other Web application drafting tools.

2. Ability for the beneficiary's family members to open an account with the service provider.

3. Ability to tie into an institution account that family member has set up with a third party. In some embodiments the financial institution account may be limited to pre-determined types, such as ESA, QTP, UGMA and UTMA. In some embodiments, to the extent that IRS regulations and financial institutions permit transfer of funds from an UGMA account to Coverdell IRA and/or a section 529 account, the system provides input screens allowing the subscriber to transfer funds from one to the other.

4. The service provider can handle a variety of payment options including credit card, debit card, prepaid card, electronic funds transfer, or payment processing services (such as PayPal).

5. In some embodiments, the service provider handles wire transactions.

6. The service provider may have the option to either charge a handling/transaction fee and/or a subscription fee. In some embodiments, the subscriber provides a payment mechanism at the time of registration, such as a credit card, debit card, prepaid card, electronic funds transfer, or payment processing service (such as PayPal). Subsequently the handling/transaction fee and subscription fee are both charged to the subscriber's financial instrument. In some embodiments, the subscriber is given one or two optional selections to: (1) include in the solicitation a request that the donor pay the transaction fee, or (2) include in the solicitation a notice that the donor's financial instrument will also be charged for the transaction fee. Where the donor is requested to pay the transaction fee, the donor user interface may be provided with a check box to allow the donor an easy-to-use tool to choose to pay the transaction fee; the system automatically computes the transaction fee and adds it to the amount charged to the donor's financial instrument.

7. In some embodiments, the service provider that operates the Web based service enters into relationships with one or more financial institutions that operate ESA, QTP, UGMA and UTMA accounts. The service may include a sponsored list of financial institutions that pay an advertising fee in order to be included in the list of financial institutions.

8. Example of Operation

Mr. X has a child Will. Will's birthday is coming up. Mr. X feels this time Jr. has enough toys and things. He is worried about college education but not sure how to save. He goes to the service provider web site and learns about how to save for school. He contacts a vendor/financial site listed on the service provider site such as a bank or eTrade type organization. He opens a Coverdell ESA account. The vendor pays the service provider for Mr. X to open the service provider's account. The service provider sends a packet to Mr. X with a message such as, “Happy Birthday, go to the service provider's web site,” and an assigned account number. People can now send checks, credit card money, or wire money to the service provider for Will's birthday gift for school. The vendor sends Mr. X the final statement.

Although an example is provided above for an education account, in other embodiments, the gifts are donated to a trust account on behalf of a person with special needs.

Although an example is provided above in which the subscriber, donor and beneficiary are three different people, that is optional. The subscriber may also make donations to the account, acting as a donor and subscriber. The beneficiary may make donations to his or her own existing account, acting as donor and beneficiary. A student may also open an individual account for his or her own direct-gifts-toward his/her education, acting as subscriber, donor and beneficiary. This allows anyone to take advantage of the service including, but not limited to, people in higher education already working toward a degree or advancement or trade.

The present invention may be embodied in the form of computer-implemented processes and apparatus for practicing those processes. The present invention may also be embodied in the form of computer program code embodied in tangible machine readable storage media, such as random access memory (RAM), floppy diskettes, read only memories (ROMs), CD-ROMs, hard disk drives, flash memories, or any other machine-readable storage medium, wherein, when the computer program code is loaded into and executed by a computer, the computer becomes an apparatus for practicing the invention. The present invention may also be embodied in the form of computer program code, whether stored in a storage medium, loaded into and/or executed by a computer, such that, when the computer program code is loaded into and executed by a computer, the computer becomes an apparatus for practicing the invention. When implemented on a general-purpose processor, the computer program code segments configure the processor to create specific logic circuits. The invention may alternatively be embodied in a digital signal processor formed of application specific integrated circuits for performing a method according to the principles of the invention.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A system comprising:
a computer readable storage medium storing a database of subscriber records, each subscriber record associated with a respective subscriber;
a computer processor connected to the computer readable storage medium and to a communications network, the processor configured to:
receive, from the subscriber via the network, information specifying at least one beneficiary, at least one donor, and at least one account from the group consisting of a Coverdell Education Savings Account (ESA), a Qualified Tuition Plan (QTP) under Internal Revenue Code section 529, a Uniform Gift to Minors Act (UGMA) account and a Uniform Transfers to Minors Act (UTMA) account;
receive from the subscriber an identification of a time period selected by the subscriber;
store information related to the beneficiary, the donor, the account and the time period in one or more records in the database, the one or more records being associated with the subscriber; and
automatically send via the network during the time period selected by the subscriber, an invitation to the donor to contribute to the account, the invitation including information to direct the donor to a web page for making an online contribution to the account.

2. The system of claim 1, wherein the information to direct the donor includes a link to a web page operated by a payment processing service, such that the web page is configured to allow the donor to make an online contribution to the account via the web page of the payment processing service.

3. The system of claim 1, wherein the computer processor is further configured to render at least one web page for prompting the subscriber to input the time period during which the invitation is to be automatically sent.

4. The system of claim 3, wherein the computer processor is further configured to prompt the subscriber to input content for the invitation.

5. The system of claim 3, wherein:
the subscriber record identifies a plurality of beneficiaries, and
the at least one web page prompts the user to select the beneficiary from among the plurality of beneficiaries.

6. The system of claim 1, wherein the computer processor is further configured to generate a report containing a list of contributions that have been made to the account.

7. The system of claim 6, wherein the computer processor is configured to render a web page that permits the donor to input an amount of an offline contribution, and the list includes the offline contribution.

8. The system of claim 1, wherein the information to direct the donor includes a link to a web page operated by a financial institution at which the account is maintained, such that the web page is configured to allow the donor to make an online contribution to the account via the web page of the financial institution.

9. A method comprising:
receiving, from a subscriber via a communications network, information identifying at least one beneficiary, at least one donor, and at least one account from the group consisting of a Coverdell Education Savings Account (ESA), a Qualified Tuition Plan (QTP) under Internal Revenue Code section 529, a Uniform Gift to Minors Act (UGMA) account and a Uniform Transfers to Minors Act (UTMA) account; and
receiving from the subscriber an identification of a time period selected by the subscriber;
storing information related to the beneficiary, the donor, the account and the time period in one or more records in the database, the one or more records being associated with the subscriber;
automatically sending via the network during the time period selected by the subscriber, an invitation to the donor to contribute to the account, the invitation including information to direct a browser of the donor to a web page for making an online contribution to the account.

10. The method of claim 9, further comprising:
receiving a notification that the donor has made an online contribution; and
generating a report including the online contribution.

11. The method of claim 9, further comprising rendering one or more web pages that prompt the subscriber to input:
the selected time period; and
message content to be included in the invitation.

12. A computer readable storage medium encoded with computer program code, such that when the computer program code is executed by a processor, the processor performs a method comprising:
receiving, from a subscriber via a communications network, information identifying at least one beneficiary, at least one donor, and at least one account from the group consisting of a Coverdell Education Savings Account (ESA), a Qualified Tuition Plan (QTP) under Internal Revenue Code section 529, a Uniform Gift to Minors Act (UGMA) account and a Uniform Transfers to Minors Act (UTMA) account; and
receiving from the subscriber an identification of a time period selected by the subscriber;
storing information related to the beneficiary, the donor, the account and the time period in one or more records in the database, the one or more records being associated with the subscriber;
automatically sending via the network during the time period selected by the subscriber, an invitation to the donor to contribute to the account, the invitation including information to direct a browser of the donor to a web page for making an online contribution to the account.
